(19) United States
(12) Patent Application Publication
(10) Pub. No.: US 2025/0279244 A1
(43) Pub. Date: Sep. 4, 2025

(54) CERAMIC ELECTRONIC DEVICE AND MANUFACTURING METHOD OF THE SAME

(71) Applicant: TAIYO YUDEN CO., LTD., Tokyo (JP)

(72) Inventors: Yusuke KOWASE, Tokyo (JP); Tetsuki SAITO, Tokyo (JP)

(73) Assignee: TAIYO YUDEN CO., LTD., Tokyo (JP)

(21) Appl. No.: 19/211,773

(22) Filed: May 19, 2025

Related U.S. Application Data
(63) Continuation of application No. PCT/JP2023/041636, filed on Nov. 20, 2023.

(30) Foreign Application Priority Data
Nov. 30, 2022 (JP) 2022-192185

(51) Int. Cl. H01G 4/30; H01G 4/12; H01G 4/232

(52) U.S. Cl. CPC H01G 4/30; H01G 4/12; H01G 4/232

(57) ABSTRACT

A ceramic grain is provided across an interface between an external electrode and a multilayer chip. In a dielectric layer of a capacity section, a standard deviation of grain size of ceramic grains is 30 nm or less. In an outer periphery surrounding the capacity section of the multilayer chip, a standard deviation of grain size of ceramic grains is 15 nm or less. An average grain size of the ceramic grains in the plurality of dielectric layer of the capacity section is larger than an average grain size of the ceramic grains in the outer periphery.

### CROSS-REFERENCE TO RELATED APPLICATION

This application is a continuation application of PCT/JP2023/041636 filed on Nov. 20, 2023, which claims priority to Japanese Patent Application No. 2022-192185 filed on Nov. 30, 2022, the contents of which are herein wholly incorporated by reference.

### FIELD

A certain aspect of the present invention relates to a ceramic electronic device and a manufacturing method of the ceramic electronic device.

### BACKGROUND

In high-frequency communication systems, such as mobile phones, multilayer ceramic capacitors are used as ceramic electronic devices to achieve the high current, current stabilization, and removal of high-frequency components that are required for the high performance and functionality of electronic devices.

### SUMMARY OF THE INVENTION

According to an aspect of the present invention, there is provided a ceramic electronic device including: a multilayer chip in which a plurality of dielectric layers and a plurality of internal electrode layers are alternately stacked and has a substantially rectangular parallelepiped shape, and the plurality of internal electrode layers are alternately exposed at a first end face and a second end face opposed to each other of the substantially rectangular parallelepiped shape; and a first external electrode formed on the first end face; and a second external electrode formed on the second end face, wherein a ceramic grain is provided across an interface between the first external electrode and the multilayer chip, wherein in at least one of the plurality of dielectric layers of a capacity section, which is a section where a first set of the plurality of internal electrode layers connected to the first external electrode and a second set of the plurality of internal electrode layers connected to the second external electrode face each other, a standard deviation of grain size of ceramic grains is 30 nm or less, wherein in at least a portion of an outer periphery surrounding the capacity section of the multilayer chip, a standard deviation of grain size of ceramic grains is 15 nm or less, and wherein an average grain size of the ceramic grains in the at least one of the plurality of dielectric layers of the capacity section is larger than an average grain size of the ceramic grains in the at least a portion.

According to another aspect of the present invention, there is provided a manufacturing method of a ceramic electronic device including: forming each of internal electrode patterns on each of dielectric green sheets; forming each of dielectric patterns around each of the internal electrode patterns on each of the dielectric green sheet, the dielectric patterns including ceramic powder having an average particle size smaller than that of ceramic powder of the dielectric green sheets; forming a multilayer structure by stacking the dielectric green sheets each on which each of the internal electrode patterns and each of the dielectric patterns are formed; and forming dielectric layers from the dielectric green sheets, internal electrode layers from the internal electrode patterns, first and second external electrodes from a conductive paste containing ceramic powder, by firing the conductive paste onto two end faces of the multilayer structure, simultaneously with or after firing the multilayer structure, wherein a ceramic grain is provided at an interface between the first external electrode and the multilayer structure so as to be provided across the interface, wherein in at least one of the dielectric layers of a capacity section, which is a section where a first set of the internal electrode layers connected to the first external electrode and a second set of the internal electrode layers connected to the second external electrode face each other, a standard deviation of grain size of ceramic grains is 30 nm or less, and in at least a portion of an outer periphery surrounding the capacity section in the multilayer structure, a standard deviation of grain size of ceramic grains is 15 nm or less, and an average grain size of the ceramic grains in the at least one of the dielectric layers of the capacity section is larger than an average grain size of the ceramic grains in the at least a portion.

According to another aspect of the present invention, there is provided a manufacturing method of a ceramic electronic device including: forming each of internal electrode patterns on each of dielectric green sheets; forming a multilayer structure by stacking the dielectric green sheets each on which each of the internal electrode patterns is formed; and forming side margins containing ceramic powder having an average particle size smaller than that of ceramic powder in the dielectric green sheets on two side faces other than upper and lower faces in a stacking direction and two end faces of the multilayer structure; and forming dielectric layers from the dielectric green sheets, internal electrode layers from the internal electrode patterns, and first and second external electrodes from a conductive paste containing ceramic powder, by firing the conductive paste onto two end faces of the multilayer structure, simultaneously with or after firing the multilayer structure on which the side margins are formed, wherein a ceramic grain is provided at an interface between the first external electrode and the multilayer structure so as to be provided across the interface, wherein in at least one of the dielectric layers of a capacity section, which is a section where a first set of the internal electrode layers connected to the first external electrode and a second set of the internal electrode layers connected to the second external electrode face each other, a standard deviation of grain size of ceramic grains is 30 nm or less, and in at least a portion of an outer periphery surrounding the capacity section in the multilayer structure, a standard deviation of grain size of ceramic grains is 15 nm or less, and an average grain size of the ceramic grains in the at least one of the dielectric layers of the capacity section is larger than an average grain size of the ceramic grains in the at least a portion.

### BRIEF DESCRIPTION OF THE DRAWINGS

FIG. 1 illustrates a perspective view of a multilayer ceramic capacitor in which a cross section of a part of the multilayer ceramic capacitor is illustrated;

FIG. 2 illustrates a cross sectional view taken along a line A-A of FIG. 1;

FIG. 3 illustrates a cross sectional view taken along a line B-B of FIG. 1;

FIG. 4 illustrates an enlarged view of a vicinity of an external electrode;

FIG. 5 illustrates a continuity modulus;

FIG. 6 illustrates an enlarged view of an XZ cross section of a vicinity of an external electrode;

FIG. 7 illustrates an enlarged view of an YZ cross section of a vicinity of an external electrode;

FIG. 8A illustrates an enlarged view of a cross section of a capacity section;

FIG. 8B illustrates a grain size;

FIG. 9 illustrates an enlarged view of a YZ cross section of a vicinity of a side margin;

FIG. 10 illustrates a XZ cross section of a vicinity of a capacity section and an end margin;

FIG. 11 illustrates details of a ceramic grain;

FIG. 12 illustrates a manufacturing method of a multilayer ceramic capacitor;

FIG. 13A and FIG. 13B illustrate an internal electrode formation process;

FIG. 14 illustrates a stacking process; and

FIG. 15 illustrates a case where a side margin portions attached or applied to a multilayer structure later.

### DETAILED DESCRIPTION

In order to ensure a stable flow of large current within a limited mounting area, it is necessary to miniaturize ceramic electronic devices and increase their capacity. To achieve this, it is effective to thin the dielectric layers and internal electrode layers, and to thin the external electrodes. However, thinning the internal electrode layers reduces the continuity modulus of the internal electrode layers, and thinning the external electrodes may cause peeling.

A description will be given of an embodiment with reference to the accompanying drawings.

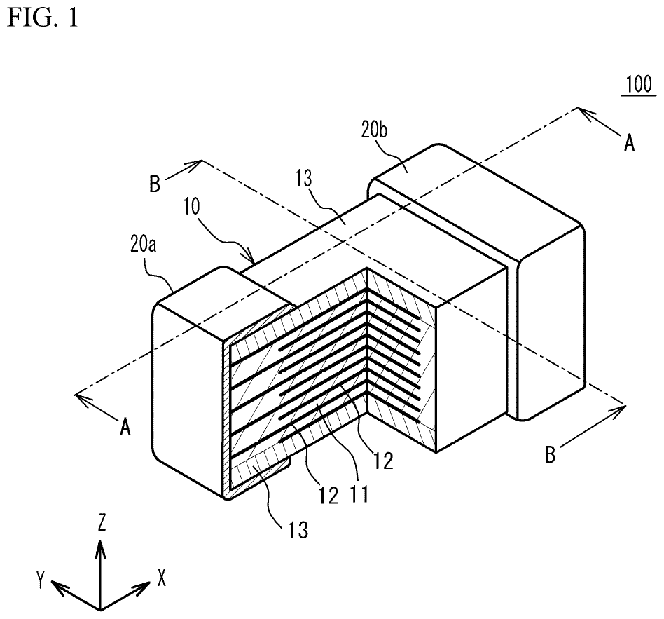

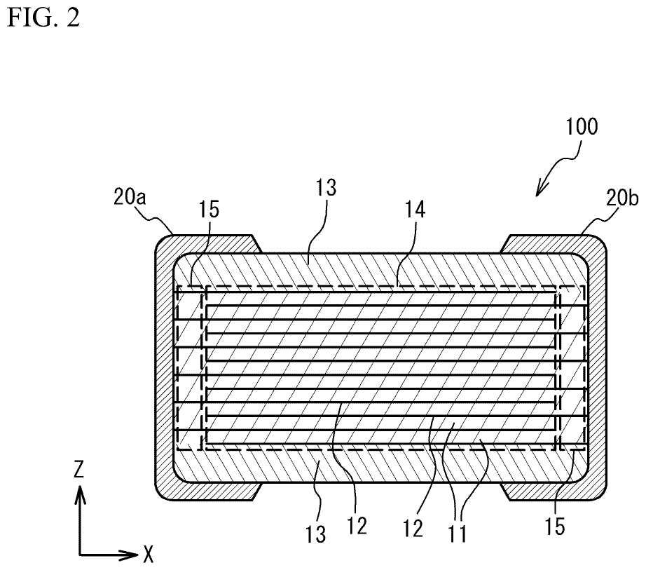

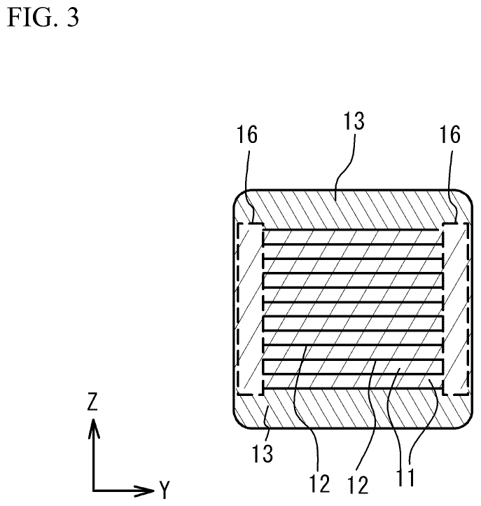

(Embodiment) FIG. 1 illustrates a perspective view of a multilayer ceramic capacitor 100 in accordance with an embodiment, in which a cross section of a part of the multilayer ceramic capacitor 100 is illustrated. FIG. 2 illustrates a cross sectional view taken along a line A-A of FIG. 1. FIG. 3 illustrates a cross sectional view taken along a line B-B of FIG. 1. As illustrated in FIG. 1 to FIG. 3, the multilayer ceramic capacitor 100 includes a multilayer chip 10 having a rectangular parallelepiped shape, and a pair of external electrodes 20a and 20b that are respectively provided at two end faces of the multilayer chip 10 facing each other. In four faces other than the two end faces of the multilayer chip 10, two faces other than an upper face and a lower face of the multilayer chip 10 in a stacking direction are referred to as side faces. The external electrodes 20a and 20b extend to the upper face, the lower face and the two side faces of the multilayer chip 10. However, the external electrodes 20a and 20b are spaced from each other.

In FIG. 1 to FIGS. 3, 1 to 3, a Z-axis direction is the direction in which internal electrode layers 12 face each other, the stacking direction of the dielectric layers 11, and the direction in which the upper face and the lower face of the multilayer chip 10 face each other. An X-axis direction is the length direction of the multilayer chip 10, the direction in which the two end faces of the multilayer chip 10 face each other, the direction in which the external electrodes 20a and 20b face each other, and the longitudinal direction in which the dielectric layers 11 extend. A Y-axis direction is the width direction of the internal electrode layers 12, and the direction in which the two side faces other than the two end faces of the four side faces of the multilayer chip 10 face each other. The X-axis direction, the Y-axis direction and the Z-axis direction are orthogonal to each other.

The multilayer chip 10 has a configuration in which dielectric layers 11 containing a ceramic material that functions as a dielectric and the internal electrode layers 12 of which a main component is a metal are alternately stacked. In other words, the multilayer chip 10 includes the plurality of internal electrode layers 12 facing each other, and the dielectric layers 11 sandwiched between the plurality of internal electrode layers 12. The edges of the internal electrode layers 12 in a direction in which the internal electrode layers extend are alternately exposed to the first end face of the multilayer chip 10 on which the external electrode 20a is provided and the second end face on which the external electrode 20b is provided. The internal electrode layer 12 connected to the external electrode 20a is not connected to the external electrode 20b, and the internal electrode layer 12 connected to the external electrode 20b is not connected to the external electrode 20a. As a result, each of the internal electrode layers 12 is alternately conductive to the external electrode 20a and the external electrode 20b. In addition, in the multilayer structure of the dielectric layers 11 and the internal electrode layers 12, the internal electrode layers 12 are arranged on both outermost layers in the stacking direction, and the internal electrode layers 12 of the outermost layers are covered by cover layers 13. The cover layers 13 are mainly composed of a ceramic material. For example, the cover layers 13 may have the same composition as the dielectric layers 11 or may have a different composition. As long as the internal electrode layers 12 are exposed on two different surfaces and are electrically connected to different external electrodes, the configurations are not limited to those illustrated in FIG. 1 to FIG. 3.

For example, the multilayer ceramic capacitor 100 may have a length of 0.25 mm, a width of 0.125 mm, and a height of 0.125 mm. The multilayer ceramic capacitor 100 may have a length of 0.4 mm, a width of 0.2 mm, and a height of 0.2 mm. The multilayer ceramic capacitor 100 may have a length of 0.6 mm, a width of 0.3 mm, and a height of 0.3 mm. The multilayer ceramic capacitor 100 may have a length of 1.0 mm, a width of 0.5 mm, and a height of 0.5 mm. The multilayer ceramic capacitor 100 may have a length of 3.2 mm, a width of 1.6 mm, and a height of 1.6 mm. The multilayer ceramic capacitor 100 may have a length of 4.5 mm, a width of 3.2 mm, and a height of 2.5 mm. However, the size of the multilayer ceramic capacitor 100 is not limited to the above sizes.

The internal electrode layers 12 are mainly composed of base metals such as nickel (Ni), copper (Cu), or tin (Sn), or alloys thereof. As the main component of the internal electrode layers 12, noble metals such as platinum (Pt), palladium (Pd), silver (Ag), or gold (Au), or alloys containing these metals, may be used. The internal electrode layers 12 are composed only of metal components and do not contain ceramic grains such as co-materials. The average thickness of each of the internal electrode layers 12 in the Z-axis direction is, for example, 0.5 μm or less, and preferably 0.4 μm or less. The average thickness of each of the internal electrode layers 12 can be measured by observing the cross section of the multilayer ceramic capacitor 100 with a SEM (scanning electron microscope), measuring the thickness at 10 points for each of the 10 different internal electrode layers 12, and deriving the average value of all the measurement points.

A main component of the dielectric layer 11 is a ceramic material having a perovskite structure expressed by a general formula ABO₃. The perovskite structure includes ABO_{3-α} having an off-stoichiometric composition. For example, the ceramic material is such as BaTiO₃ (barium titanate), CaZrO₃ (calcium zirconate), CaTiO₃ (calcium titanate), SrTiO₃ (strontium titanate), MgTiO₃ (magnesium titanate), Ba_{1-x-y}CaₓSr_{y}Ti_{1-z}Zr₂O₃ (0≤x≤1, 0≤y≤1, 0≤z≤1) having a perovskite structure. Ba_{1-x-y}CaₓSr_{y}Ti_{1-z}Zr₂O₃ may be barium strontium titanate, barium calcium titanate, barium zirconate, barium titanate zirconate, calcium titanate zirconate, barium calcium titanate zirconate or the like. For example, the dielectric layers 11 contain 90 at % or more of the main component ceramic. The average thickness of each of the dielectric layers 11 in the Z-axis direction is, for example, 0.5 μm or less, and preferably 0.3 μm or less. The average thickness of each of the internal electrode layers 12 in the Z-axis direction can be measured by observing a cross section of the multilayer ceramic capacitor 100 with a SEM (scanning electron microscope), measuring the thickness at 10 points for each of the 10 different dielectric layers 11, and deriving the average value of all the measurement points.

Additives may be added to the dielectric layer 11. An additive to the dielectric layer 11, is such as an oxide of Ze (zirconium), Hf (Hafnium), Mg (magnesium), Mn (manganese), Mo (molybdenum), vanadium (V), chromium (Cr), or a rare earth element (Y (yttrium), Sm (samarium), Eu (europium), Gd (gadolinium), Tb (terbium), Dy (dysprosium), Ho (holmium), Er (erbium), Tm (thulium) or Yb (ytterbium), or an oxide of Co (cobalt), Ni (nickel), Li (lithium), B (boron), Na (sodium), K (potassium) or Si (silicon), or a glass including cobalt, nickel, lithium, boron, sodium, potassium or silicon.

As illustrated in FIG. 2, a section, in which a set of the internal electrode layers 12 connected to the external electrode 20a face another set of the internal electrode layers 12 connected to the external electrode 20b, is a section generating electrical capacity in the multilayer ceramic capacitor 100. Accordingly, the section is referred to as a capacity section 14. That is, the capacity section 14 is a section in which the internal electrode layers next to each other being connected to different external electrodes face each other.

A section, in which the internal electrode layers 12 connected to the external electrode 20a face each other without sandwiching the internal electrode layer 12 connected to the external electrode 20b, is referred to as an end margin 15. A section, in which the internal electrode layers 12 connected to the external electrode 20b face each other without sandwiching the internal electrode layer 12 connected to the external electrode 20a is another end margin 15. That is, the end margin 15 is a section in which a set of the internal electrode layers 12 connected to one external electrode face each other without sandwiching the internal electrode layer 12 connected to the other external electrode. The end margins 15 are sections that do not generate electrical capacity in the multilayer ceramic capacitor 100.

As illustrated in FIG. 3, in the multilayer chip 10, a side margin 16 is a section provided so as to cover the ends (ends in the Y-axis direction) of two side faces of the dielectric layer 11 and the internal electrode layer 12. In other words, the side margin 16 is a section provided outside the capacity section 14 in the Y-axis direction. The side margin 16 is also a section that does not generate electrical capacity.

In the multilayer chip 10, the cover layer 13, the end margin 15, and the side margin 16 surround the capacity section 14. The cover layer 13, the end margin 15, and the side margin 16 are sometimes collectively referred to as the outer periphery.

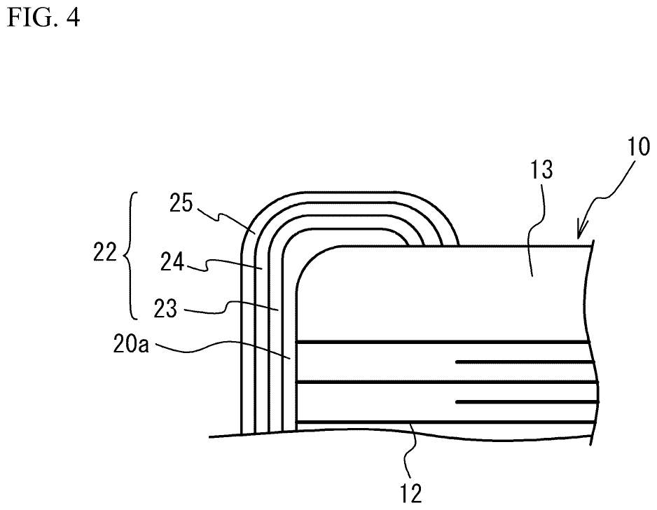

FIG. 4 is an enlarged cross-sectional view of the vicinity of the external electrode 20a. In FIG. 4, hatches are omitted. As illustrated in FIG. 4, a plated layer 22 may be provided on the outer surface of the external electrode 20a, using the external electrode 20a as a base layer. The external electrode 20a has Cu as a main component. The external electrode 20a may contain a glass component. The plated layer 22 mainly contains metals such as Cu, Ni, aluminum (Al), zinc (Zn), and Sn, or alloys of two or more of these metals. The plated layer 22 may be a plated layer of a single metal component, or may be a plurality of plated layers of mutually different metal components. For example, the plated layer 22 has a structure in which a first plated layer 23, a second plated layer 24, and a third plated layer 25 are formed in order from the external electrode 20a side. The first plated layer 23 is, for example, a Cu-plated layer. The second plated layer 24 is, for example, a Ni plated layer. The third plated layer 25 is, for example, a Sn-plated layer. Although FIG. 4 illustrates the external electrode 20a, the plated layer 22 may be similarly provided on the outer surface of the external electrode 20b.

In order to achieve a small size and large capacity in such a structure, it is effective to thin the internal electrode layer 12 and the external electrode. However, if the internal electrode layer 12 is thinned, there is a risk that the continuity modulus of the internal electrode layer 12 will decrease. If the external electrodes 20a, 20b are thinned, there is a risk that the external electrodes 20a, 20b will peel off.

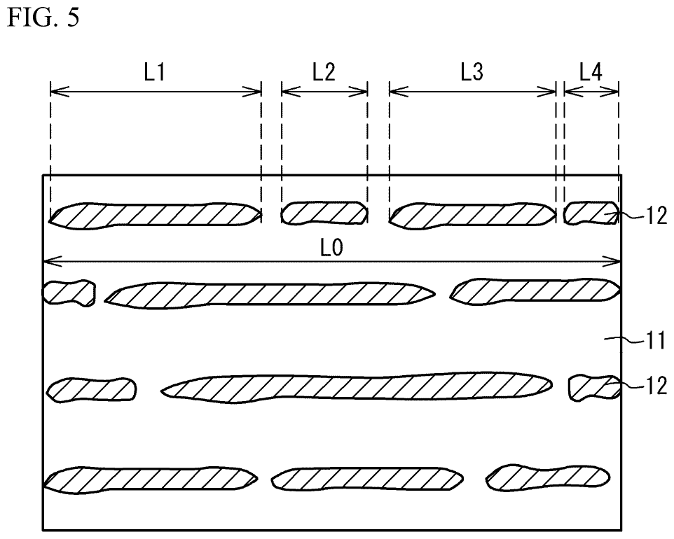

Now, the continuity modulus will be explained. FIG. 5 is a diagram illustrating the continuity modulus. As illustrated in FIG. 5, in an observation area of length L0 in a certain internal electrode layer 12, the lengths L1, L2, . . . , Ln of the metal parts are measured and added up, and the ratio of the metal parts, ΣLn/L0, can be defined as the continuity modulus of that layer. The closer this continuity modulus is to 100%, the better the continuity of the internal electrode layer 12 is.

The multilayer ceramic capacitor 100 according to this embodiment has a configuration that can improve the continuity modulus of the internal electrode layer 12 and suppress peeling of the external electrodes 20a, 20b.

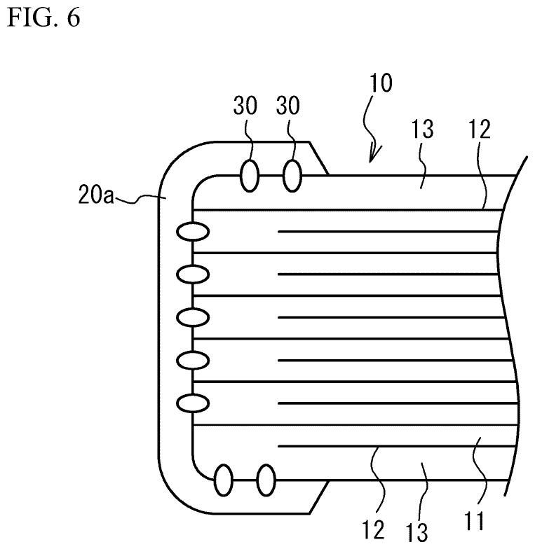

FIG. 6 is an XZ cross-sectional view further enlarging the vicinity of the external electrode 20a. In FIG. 6, the hatching representing the cross section is omitted. As illustrated in FIG. 6, ceramic grains 30 are provided across both the external electrode 20a and the multilayer chip 10 at the interface between the external electrode 20a and the multilayer chip 10. For example, the multiple ceramic grains 30 are provided. The ceramic grains 30 are also provided across both the external electrode 20b and the multilayer chip 10 at the interface between the external electrode 20b and the multilayer chip 10. The ceramic grains 30 function as wedges at the interfaces between the external electrodes 20a, 20b and the multilayer chip 10, improving the adhesion strength of the external electrodes 20a, 20b. This can suppress the external electrodes 20a, 20b from peeling off.

The diameter (length in the major axis direction) of the ceramic grains 30 is, for example, about 20 nm or more and 200 nm or less.

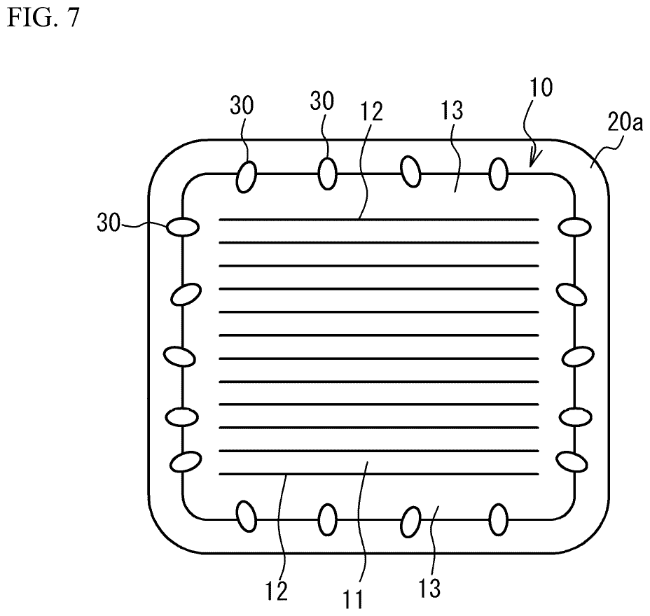

FIG. 7 is a diagram illustrating a YZ cross section near the external electrode 20a. As illustrated in FIG. 7, the ceramic grains 30 are provided across both the external electrode 20a and the multilayer chip 10 at the interface between the external electrode 20a and the upper face of the multilayer chip 10 (the interface between the external electrode 20a and the upper cover layer 13). Similarly, the ceramic grains 30 are provided across both the external electrode 20b and the multilayer chip 10 at the interface between the external electrode 20b and the upper face of the multilayer chip 10 (the interface between the external electrode 20b and the upper cover layer 13).

In addition, the ceramic grains 30 are provided across both the external electrode 20a and the multilayer chip 10 at the interface between the external electrode 20a and the lower face of the multilayer chip 10 (the interface between the external electrode 20a and the lower cover layer 13). Similarly, at the interface between the external electrode 20b and the lower face of the multilayer chip 10 (the interface between the external electrode 20b and the lower cover layer 13), the ceramic grains 30 are provided across both the external electrode 20b and the multilayer chip 10.

Furthermore, at the interface between the external electrode 20a and the side face of the multilayer chip 10 (the interface between the external electrode 20a and the side margin 16), the ceramic grains 30 are provided across both the external electrode 20a and the multilayer chip 10. Similarly, at the interface between the external electrode 20b and the side face of the multilayer chip 10 (the interface between the external electrode 20b and the side margin 16), the ceramic grains 30 are provided across both the external electrode 20b and the multilayer chip 10.

The thinner the external electrodes 20a, 20b are made, the more compact the multilayer ceramic capacitor 100 can be. In this embodiment, the thickness of each of the external electrodes 20a, 20b is preferably 20 μm or less on average, more preferably 15 μm or less, and even more preferably 12 μm or less. Even if the external electrodes 20a, 20b are thinned in this manner, peeling of the external electrodes 20a, 20b can be suppressed by providing the ceramic grains 30 across both the external electrodes and the multilayer chip 10.

It is sufficient that the ceramic grains 30 are provided in at least a portion of the interface between the multilayer chip 10 and the external electrodes 20a, 20b.

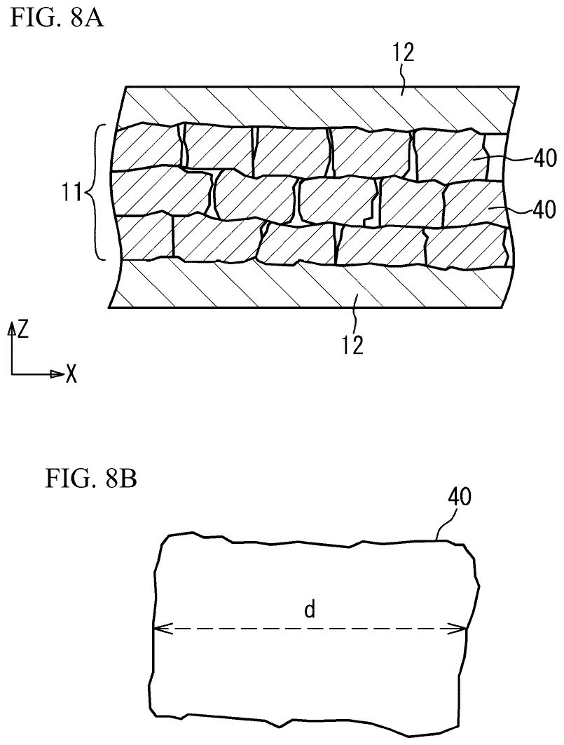

FIG. 8A is an enlarged cross-sectional view of the capacity section 14. As illustrated in FIG. 8A, the dielectric layer 11 in the capacity section 14 has a structure in which a plurality of ceramic grains 40 are sintered.

As illustrated in FIG. 8A, the ceramic grains 40 have a uniform grain size. Specifically, the standard deviation of the grain size of the ceramic grains 40 is 30 nm or less. To further regulate the grain size of the ceramic grains 40, the standard deviation of the grain size of the ceramic grains 40 is preferably 25 nm or less, and more preferably 20 nm or less.

Note that the grain size refers to the length “d” of the long side, not the diagonal, as illustrated in FIG. 8B.

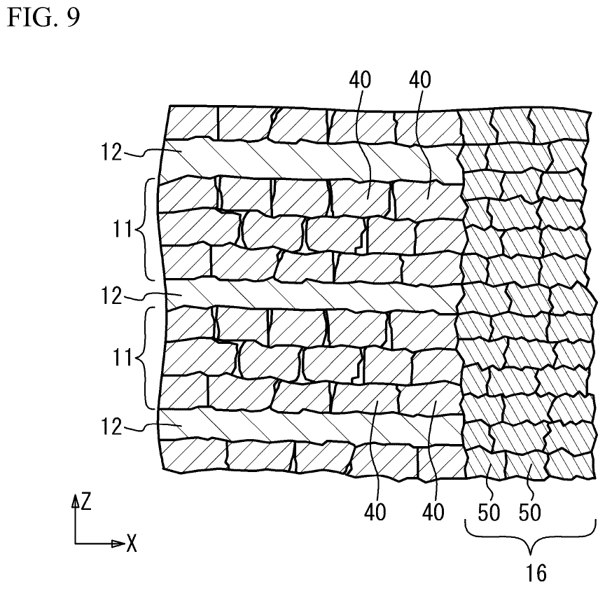

FIG. 9 is an enlarged YZ cross-sectional view of the vicinity of the side margin 16. As illustrated in FIG. 9, the side margin 16 has a structure in which a plurality of ceramic grains 50 are sintered. The grain size of the ceramic grains 50 is also uniform. Specifically, the standard deviation of the grain size of the ceramic grains 50 is 15 nm or less. To further regulate the grain size of the ceramic grains 50, the standard deviation of the grain size of the ceramic grains 50 is preferably 10 nm or less, and more preferably 5 nm or less.

The average grain size of the ceramic grains 40 is larger than the average grain size of the ceramic grains 50. With this configuration, the surface of the dielectric layer 11 of the capacity section 14 becomes flat, and therefore the internal electrode layer 12 adjacent to the dielectric layer 11 also becomes flat. This makes it possible to improve the continuity modulus of the internal electrode layer 12.

The average grain size of the ceramic grains 40 is preferably 30 nm or more and 100 nm or less, more preferably 30 nm or more and 80 nm or less, and even more preferably 40 nm or more and 60 nm or less.

The average grain size of the ceramic grains 50 is preferably 10 nm or more and 50 nm or less, more preferably 10 nm or more and 40 nm or less, and even more preferably 10 nm or more and 30 nm or less.

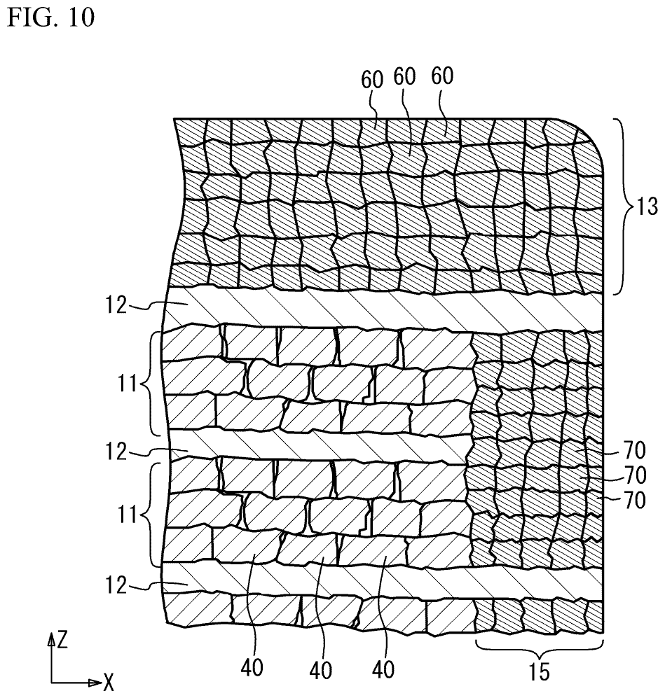

FIG. 10 is an XZ cross-sectional view of the vicinity of the capacity section 14, the cover layer 13, and the end margin 15. As illustrated in FIG. 10, the cover layer 13 has a structure in which a plurality of ceramic grains 60 are sintered. The grain size of the ceramic grains 60 is also uniform. Specifically, the standard deviation of the grain size of the ceramic grains 60 is 15 nm or less. To further uniform the grain size of the ceramic grains 60, the standard deviation of the grain size of the ceramic grains 60 is preferably 10 nm or less, and even more preferably 5 nm or less.

The average grain size of the ceramic grains 40 is larger than the average grain size of the ceramic grains 60. With this configuration, the surface of the dielectric layer 11 of the capacity section 14 becomes flat, and the internal electrode layer 12 adjacent to the dielectric layer 11 also becomes flat. This improves the continuity modulus of the internal electrode layer 12.

The average grain size of the ceramic grains 60 is preferably 10 nm or more and 50 nm or less, more preferably 10 nm or more and 40 nm or less, and even more preferably 10 nm or more and 30 nm or less.

As illustrate in FIG. 10, the end margin 15 has a structure in which a plurality of ceramic grains 70 are sintered.

As illustrated in FIG. 10, the ceramic grains 70 have a uniform grain size. Specifically, the standard deviation of the grain size of the ceramic grains 70 is 15 nm or less. To further uniform the grain size of the ceramic grains 70, the standard deviation of the grain size of the ceramic grains 70 is preferably 10 nm or less, and more preferably 5 nm or less.

The average grain size of the ceramic grains 40 is larger than the average grain size of the ceramic grains 70. With this structure, the surface of the dielectric layer 11 of the capacity section 14 is flat, and therefore the internal electrode layer 12 adjacent to the dielectric layer 11 also becomes flat. This improves the continuity modulus of the internal electrode layer 12.

The average grain size of the ceramic grains 70 is preferably 10 nm or more and 50 nm or less, more preferably 10 nm or more and 40 nm or less, and even more preferably 10 nm or more and 30 nm or less.

The standard deviation of the grain sizes of the ceramic grains 40, 50, 60, and 70 may be measured by using an electron microscope to measure the length “d” of the ceramic grains at 20 points and calculating the standard deviation. Also, the average grain size of the ceramic grains 40, 50, 60, and 70 may be measured by using an electron microscope to measure the length “d” of the ceramic grains at 20 points and calculating the average grain size.

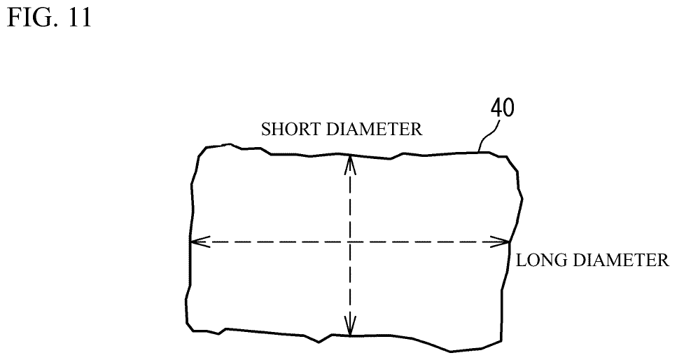

FIG. 11 is a diagram illustrating the details of the ceramic grains 40. As illustrated in FIG. 11, the ceramic grains 40 are preferably flat grains with a short diameter of 10 nm to 100 nm and a long diameter of 2 times or less than the short diameter. In this case, the filling rate of the ceramic grains 40 in the dielectric layer 11 is increased, and the dielectric layer 11 is made flatter. This can further improve the continuity modulus of the internal electrode layer 12. In addition, the long diameter of the flat grains is 1.3 times or more than the short diameter.

It is preferable that many of the ceramic grains 40 contained in the dielectric layer 11 in the capacity section 14 have the above-mentioned flat shape. This is because the filling rate of the ceramic grains 40 in the dielectric layer 11 is improved. In this embodiment, it is preferable that 10% or more of the ceramic grains 40 contained in the dielectric layer 11 in the capacity section 14 have the shape of flat grains, more preferably 50% or more have the shape of flat grains, and even more preferably 80% or more have the shape of flat grains.

As with the ceramic grains 40, the ceramic grains 30 are preferably flat grains with a short diameter of 10 nm to 100 nm and a long diameter of 2 times or less than the short diameter. In this case, the wedge action is enhanced, and peeling of the external electrodes 20a, 20b can be further suppressed. In the flat grains, the long diameter is 1.3 times or more than the short diameter.

As illustrated in FIG. 8A, it is also preferable that three or more ceramic grains 40 are arranged in the Z-axis direction in the dielectric layer 11 of the capacity section 14. In this case, since it is possible to suppress overlapping of the ceramic grains 40, it is possible to simultaneously reduce the arithmetic mean surface roughness Ra of the dielectric layer 11 and the thickness variation (Rz). The ceramic grains 40 may be stacked alternately like bricks, or may be stacked so that the short diameter and long diameter of adjacent ceramic grains are aligned vertically and horizontally.

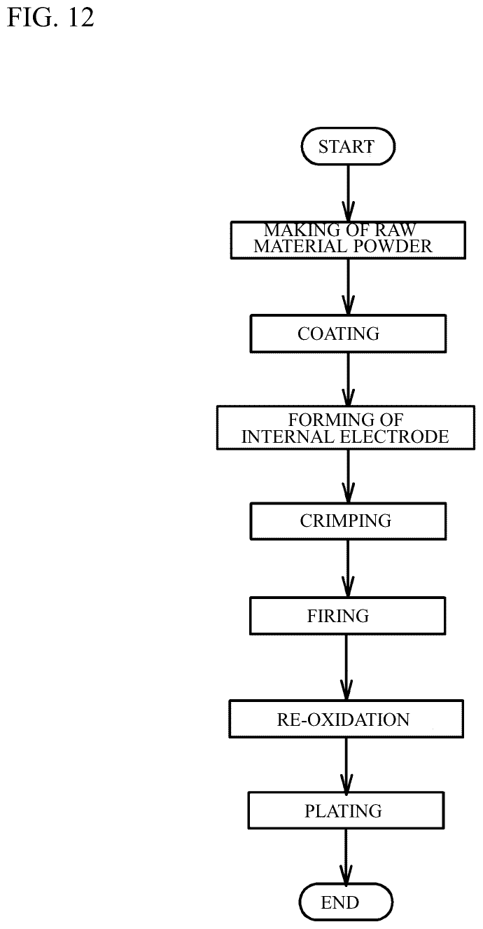

Next, a description will be given of a manufacturing method of the multilayer ceramic capacitors 100. FIG. 12 illustrates a manufacturing method of the multilayer ceramic capacitor 100.

(Making process of raw material powder) A dielectric material for forming the dielectric layer 11 is prepared. The dielectric material includes the main component ceramic of the dielectric layer 11. Generally, an A site element and a B site element are included in the dielectric layer 11 in a sintered phase of grains of ABO₃. For example, barium titanate is tetragonal compound having a perovskite structure and has a high dielectric constant. Generally, barium titanate is obtained by reacting a titanium material such as titanium dioxide with a barium material such as barium carbonate and synthesizing barium titanate. In this embodiment, elliptical or needle-shaped titanium dioxide is used to carry out hydrothermal synthesis in an aqueous solution of barium hydroxide. This allows the synthesis of flat barium titanate powder. The particle size of the resulting barium titanate powder is made uniform.

An additive compound may be added to the resulting ceramic powder, in accordance with purposes. The additive compound may be an oxide of zirconium, hafnium, magnesium, manganese, molybdenum, vanadium, chromium, a rare earth element (yttrium, samarium, europium, gadolinium, terbium, dysprosium, holmium, erbium, thulium or ytterbium), or an oxide containing cobalt, nickel, lithium, boron, sodium, potassium or silicon, or glasses containing cobalt, nickel, lithium, boron, sodium, potassium or silicon.

For example, the resulting ceramic raw material powder is wet-blended with additives and is dried and crushed. Thus, a ceramic material is obtained. For example, the particle diameter may be adjusted by crushing the resulting ceramic material as needed. Alternatively, the grain diameter of the resulting ceramic power may be adjusted by combining the crushing and classifying. With the processes, a dielectric material is obtained.

(Coating process) Next, a binder such as polyvinyl butyral (PVB) resin, an organic solvent such as ethanol or toluene, and a plasticizer are added to the obtained raw material powder and wet mixed. The obtained slurry is used to coat a dielectric green sheet 51 on a base material by, for example, a die coater method or a doctor blade method, and then dried. The base material is, for example, a polyethylene terephthalate (PET) film. A diagram illustrating the coating process is omitted.

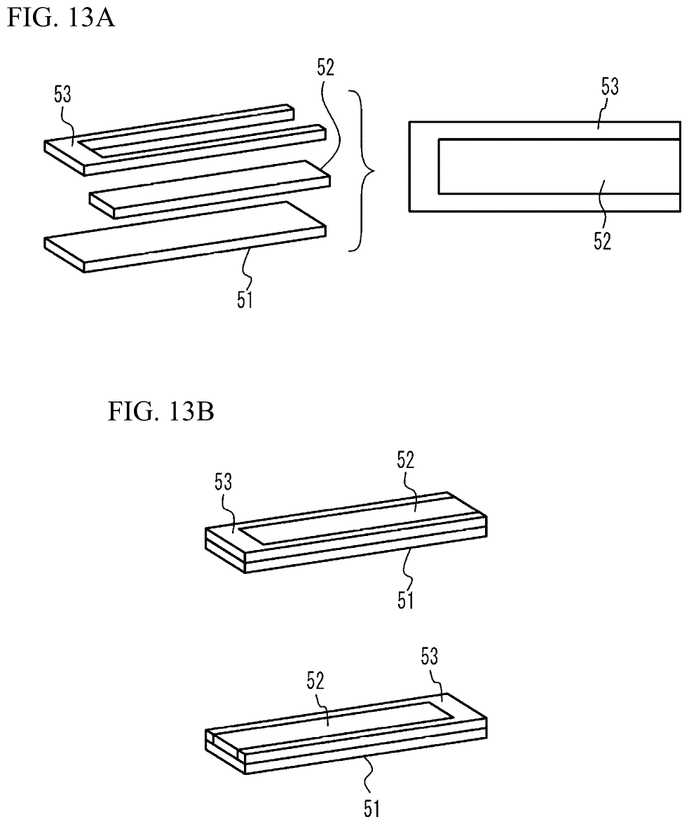

(Internal electrode formation process) Next, as illustrated in FIG. 13A, a metal conductive paste containing an organic binder for forming an internal electrode is printed on the surface of the dielectric green sheet 51 by screen printing, gravure printing, or the like, to arrange an internal electrode pattern 52 for the internal electrode layer. In addition to nickel, ceramic particles are added to the metal conductive paste as a co-material. The main component of the ceramic particles is not particularly limited, but is preferably the same as the main component ceramic of the dielectric layer 11.

Next, a binder such as an ethyl cellulose-based binder and an organic solvent such as a terpineol-based binder are added to the dielectric pattern material obtained in the making process of raw material powder, and the mixture is kneaded in a roll mill to obtain a dielectric pattern paste for the reverse pattern layer. As illustrated in FIG. 13A, the dielectric pattern paste is printed on the peripheral area of the dielectric green sheet 51 where the internal electrode pattern 52 is not printed, thereby arranging a dielectric pattern 53 and filling in the step with the internal electrode pattern 52. The dielectric green sheet 51 on which the internal electrode pattern 52 and the dielectric pattern 53 are printed is referred to as a stack unit. The particle size of the ceramic powder in the dielectric green sheet 51 is made larger than the particle size of the ceramic powder in the dielectric pattern 53.

Then, as illustrated in FIG. 13B, the stack units are stacked so that the internal electrode layers 12 and the dielectric layers 11 are alternately shifted, and so that the edges of the internal electrode layers 12 are alternately exposed on both longitudinal end faces of the dielectric layers 11 and are alternately drawn out to the pair of external electrodes 20a, 20b of opposite polarity. For example, the number of layers of the internal electrode pattern 52 is set to 100 to 500.

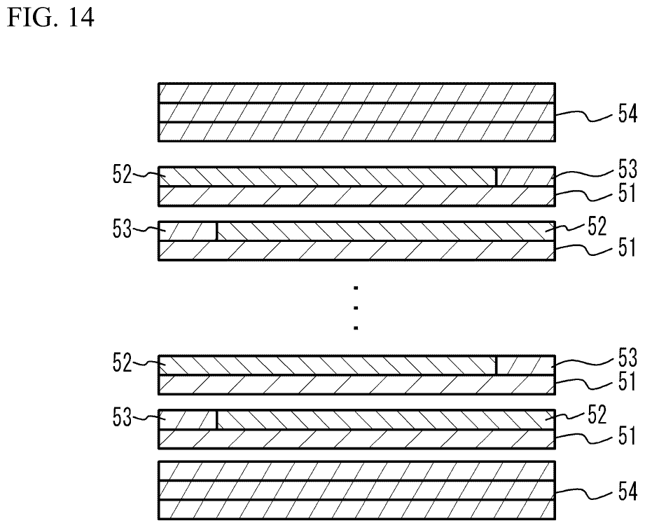

(Crimping process) As illustrated in FIG. 14, a predetermined number of cover sheets 54 (for example, 2 to 10 layers) are stacked on the top and bottom of the multilayer structure in which the stack units are stacked, and then thermally crimped. The cover sheet 54 is also a green sheet containing ceramic powder. The particle size of the ceramic powder in the dielectric green sheet 51 is set to be larger than the particle size of the ceramic powder in the cover sheet 54.

(Firing process) The ceramic multilayer structure thus obtained is subjected to a binder removal process in an N₂ atmosphere, and then coated with a metal paste that will become the base layer of the external electrodes 20a, 20b by a dipping method, and fired for 5 minutes to 10 hours in a reducing atmosphere with an oxygen partial pressure of 10-12 MPa to 10-9 MPa and a temperature of 1160° C. to 1280° C. (for example, 1180° C. or higher and 1230° C. or lower). Ceramic powder is also mixed into this metal paste. For example, the flat ceramic powder produced in the making process of raw material powder is mixed into the metal paste.

(Re-oxidation Process) In order to return oxygen to the barium titanate, which is the partially reduced main phase of the dielectric layer 11 that has been fired in a reducing atmosphere, heat treatment may be performed in a mixture of N₂ and water vapor at approximately 1000° C., or in air at 500° C. to 700° C., to the extent that the internal electrode layer 12 is not oxidized. This process is called the re-oxidation process.

(Plating process) Then, a metal coating such as copper, nickel, or tin is applied by plating on the base layer of the external electrodes 20a and 20b. Through the above process, the multilayer ceramic capacitor 100 is completed.

According to the manufacturing method of this embodiment, ceramic particles are ejected when the metal paste for forming the base layer of the external electrodes is fired. As a result, ceramic particles provided across both the multilayer chip 10 and the external electrode 20a, 20b are arranged at the interface between the multilayer chip 10 and the external electrodes 20a, 20b. In addition, by making the particle size of the ceramic powder in the dielectric green sheet 51 larger than the particle size of the ceramic powder in the dielectric pattern 53 and the cover sheet 54, the average grains size of the ceramic grains in the dielectric layer 11 of the capacity section 14 becomes larger than the average grain size of the ceramic grains in the cover layer 13, the end margin 15, and the side margin 16. In addition, by making the particle size of the ceramic powder in the dielectric green sheet 51 uniform, the standard deviation of the grain size of the ceramic grains in the dielectric layer 11 of the capacity section 14 can be made 30 nm or less. In addition, by making the particle size of the ceramic powder in the dielectric pattern 53 and the cover sheet 54 uniform, the standard deviation of the grain size of the ceramic grains in the cover layer 13, the end margin 15, and the side margin 16 can be made 15 nm or less.

It should be noted that ceramic particles provided across the multilayer chip 10 and the external electrodes 20a, 20b can also be arranged at the interface between the multilayer chip 10 and the external electrodes 20a, 20b by a method other than discharging ceramic particles. For example, flat ceramic particles can be sprinkled on the chip surface before firing, so that the flat ceramic particles can be exposed on the chip surface after firing. Then, a conductive paste for the base layer is applied and baked. In this case, the ceramic grains provided across the multilayer chip 10 and the external electrodes 20a, 20b can be arranged at the interface between the multilayer chip 10 and the external electrodes 20a, 20b.

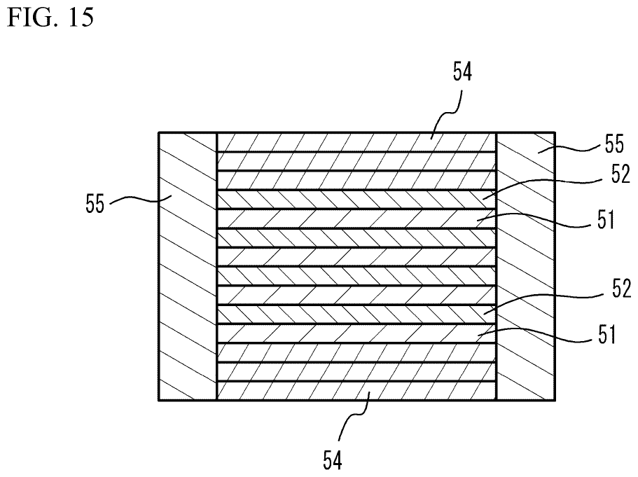

The side margin portion may be attached or applied to the side face of the multilayer structure. Specifically, as illustrated in FIG. 15, a multilayer portion is obtained by alternately stacking the dielectric green sheets 51 and the internal electrode patterns 52 having the same width as the dielectric green sheets 51. Next, a sheet formed of the dielectric pattern paste may be attached to the side face of the multilayer portion as a side margin portion 55. In this case, the particle size of the ceramic powder in the dielectric green sheet 51 may be made larger than the particle size of the ceramic powder in the side margin portion 55.

In addition, the external electrodes 20a, 20b may be formed by baking a conductive paste onto the two end faces of the multilayer chip 10 after the multilayer chip 10 has been fired.

In the embodiments, the multilayer ceramic capacitor is described as an example of ceramic electronic devices. However, the embodiments are not limited to the multilayer ceramic capacitor. For example, the embodiments may be applied to another electronic device such as varistor or thermistor.

Although the embodiments of the present invention have been described in detail, it is to be understood that the various change, substitutions, and alterations could be made hereto without departing from the spirit and scope of the invention.

1. A ceramic electronic device comprising:
a multilayer chip in which a plurality of dielectric layers and a plurality of internal electrode layers are alternately stacked and has a substantially rectangular parallelepiped shape, and the plurality of internal electrode layers are alternately exposed at a first end face and a second end face opposed to each other of the substantially rectangular parallelepiped shape; and
a first external electrode formed on the first end face; and
a second external electrode formed on the second end face,
wherein a ceramic grain is provided across an interface between the first external electrode and the multilayer chip,
wherein in at least one of the plurality of dielectric layers of a capacity section, which is a section where a first set of the plurality of internal electrode layers connected to the first external electrode and a second set of the plurality of internal electrode layers connected to the second external electrode face each other, a standard deviation of grain size of ceramic grains is 30 nm or less,
wherein in at least a portion of an outer periphery surrounding the capacity section of the multilayer chip, a standard deviation of grain size of ceramic grains is 15 nm or less, and
wherein an average grain size of the ceramic grains in the at least one of the plurality of dielectric layers of the capacity section is larger than an average grain size of the ceramic grains in the at least a portion.

2. The ceramic electronic device as claimed in claim 1,
wherein the at least one of the plurality of dielectric layers of the capacity section includes a flat grain whose short diameter is 10 nm or more and 100 nm or less and whose long diameter is twice the short diameter or less.

3. The ceramic electronic device as claimed in claim 2,
wherein, in the flat grain, the long diameter is 1.3 times or more the short diameter.

4. The ceramic electronic device as claimed in claim 2,
wherein at least 10% of the ceramic grains in the at least one of the plurality of dielectric layers of the capacity section has a shape of the flat grain.

5. The ceramic electronic device as claimed in claim 1,
wherein an average thickness of at least one of the plurality of internal electrode layers is 0.5 μm or less.

6. The ceramic electronic device as claimed in claim 1,
wherein the first external electrode has an average thickness of 20 μm or less.

7. The ceramic electronic device as claimed in claim 1,
wherein, in the at least one of the plurality of dielectric layers of the capacity section, three or more ceramic grains are aligned in a stacking direction of the plurality of dielectric layers.

8. The ceramic electronic device as claimed in claim 1, wherein the ceramic grain provided across the interface between the first external electrode and the multilayer chip is a flat grain with a short diameter of 10 nm or more and 100 nm or less and a long diameter of twice the short diameter or less.

9. A manufacturing method of a ceramic electronic device comprising:
forming each of internal electrode patterns on each of dielectric green sheets;
forming each of dielectric patterns around each of the internal electrode patterns on each of the dielectric green sheet, the dielectric patterns including ceramic powder having an average particle size smaller than that of ceramic powder of the dielectric green sheets;
forming a multilayer structure by stacking the dielectric green sheets each on which each of the internal electrode patterns and each of the dielectric patterns are formed; and
forming dielectric layers from the dielectric green sheets, internal electrode layers from the internal electrode patterns, first and second external electrodes from a conductive paste containing ceramic powder, by firing the conductive paste onto two end faces of the multilayer structure, simultaneously with or after firing the multilayer structure,
wherein a ceramic grain is provided at an interface between the first external electrode and the multilayer structure so as to be provided across the interface,
wherein in at least one of the dielectric layers of a capacity section, which is a section where a first set of the internal electrode layers connected to the first external electrode and a second set of the internal electrode layers connected to the second external electrode face each other, a standard deviation of grain size of ceramic grains is 30 nm or less, and in at least a portion of an outer periphery surrounding the capacity section in the multilayer structure, a standard deviation of grain size of ceramic grains is 15 nm or less, and an average grain size of the ceramic grains in the at least one of the dielectric layers of the capacity section is larger than an average grain size of the ceramic grains in the at least a portion.

10. A manufacturing method of a ceramic electronic device comprising:
forming each of internal electrode patterns on each of dielectric green sheets;
forming a multilayer structure by stacking the dielectric green sheets each on which each of the internal electrode patterns is formed; and
forming side margins containing ceramic powder having an average particle size smaller than that of ceramic powder in the dielectric green sheets on two side faces other than upper and lower faces in a stacking direction and two end faces of the multilayer structure; and
forming dielectric layers from the dielectric green sheets, internal electrode layers from the internal electrode patterns, and first and second external electrodes from a conductive paste containing ceramic powder, by firing the conductive paste onto two end faces of the multilayer structure, simultaneously with or after firing the multilayer structure on which the side margins are formed,
wherein a ceramic grain is provided at an interface between the first external electrode and the multilayer structure so as to be provided across the interface,
wherein in at least one of the dielectric layers of a capacity section, which is a section where a first set of the internal electrode layers connected to the first external electrode and a second set of the internal electrode layers connected to the second external electrode face each other, a standard deviation of grain size of ceramic grains is 30 nm or less, and in at least a portion of an outer periphery surrounding the capacity section in the multilayer structure, a standard deviation of grain size of ceramic grains is 15 nm or less, and an average grain size of the ceramic grains in the at least one of the dielectric layers of the capacity section is larger than an average grain size of the ceramic grains in the at least a portion.
